(19) United States
(12) Patent Application Publication
(10) Pub. No.: US 2026/0114955 A1
(43) Pub. Date: Apr. 30, 2026

(54) BOREHOLE SHIELD FOR PERFORMING AN ENDODONTIC SURGERY AND METHODS OF USING THE SAME

(71) Applicant: TYW IP HOLDING LLC, Montgomery Spring, TX (US)

(72) Inventor: Yu-Wei Tsai, Tainan (TW)

(21) Appl. No.: 18/552,198

(22) PCT Filed: Feb. 10, 2023
(86) PCT No.: PCT/US2023/062334

§ 371 Date: Sep. 25, 2023

Related U.S. Application Data
(60) Provisional application No. 63/483,746, filed on Feb. 7, 2023.

(51) Int. Cl. A61C 5/90

(52) U.S. Cl. CPC A61C 5/90

(57) ABSTRACT

A borehole shield useful for performing an endodontic surgery which includes removing a portion of the alveolar bone of a subject to create a borehole for accessing a treatment site, the borehole shield of the present disclosure includes a body configured to fit the borehole, and a sealable opening disposed on the body. The present disclosure also discloses a method for performing a periradicular surgery on a subject suffering from a pathological condition at a treatment site in need of such surgery includes creating a borehole 2024/167529 on an alveolar bone of the subject to reveal the treatment site, placing a borehole shield in the borehole such that the sealable opening form a seal around the treatment site, and applying treatment operations to the treatment site. A method of preventing surrounding fluid to enter into an endodontic surgical treatment site is disclosed. An endodontic surgical kit includes an instruction insert reciting the method for performing a periradicular surgery is also disclosed.

WO

### BACKGROUND OF THE INVENTION

### Related Application

This application claims priority to U.S. Provisional Patent Application Ser. No. 63/349,142, filed on Jun. 5, 2022, entitled “A device enabling attachment of instruments and its method of usage in apical surgery,” which is incorporated herein by reference in its entirety for all purposes.

### FIELD OF THE INVENTION

The present disclosure relates to a borehole shield useful for performing endodontic surgery, which can form a seal around the treatment site to prevent surrounding biological fluid from entering the treatment site, in particular in a periradicular surgery around the root of a tooth.

### Description of Related Art

More than 15 million root canals are performed in the US every year, under normal situations, the long-term success rate for root canal treatment ranges between 80 to 90%. In some failed cases, a defective endodontic treatment is the cause of apical periodontitis. Under certain circumstances where inflammation or infection persists in the bony area around the apical end of the tooth, endodontic surgery is required to remove the diseased tissue surrounding the root apex and to section the apical portion of the root.

The process of endodontic surgery includes raising a flap, resecting the root apex, removing the diseased tissues and the infected or improper root canal filling materials, retrograde filling, and suturing the incision. It is common for dentists to use dental operating microscopes and/or mouth mirrors to check if all the diseased periapical tissue has been removed. However, conventional surgical methods have several drawbacks: 1. The procedures must be frequently stopped to check the removal of soft tissue around the apical portion, which prolongs operating time and is labor intensive; 2. The operator's view and surgical field are often obscured by the oozing of blood, which requires frequent flushing and irrigation. This moist environment not only increases risks of post-operative infection but also the potential for recontamination from the surrounding biological fluid (e.g., saliva, blood), which may result in the failure of surgery and further complications.

Although a few inventions have been proposed in trying to solve the problem, none of them satisfy the desired operation procedure without frequently stopping to check the status, preventing biological fluid from entering the treatment site to give a relatively dry environment and a clear operation view.

### SUMMARY

Concerning the issues mentioned above, a borehole shield is provided in this disclosure to enable attachments of hand-free endoscopic accessories. This reduces procedure time interval and the burden on surgical personnel, and simultaneously blocks out foreign matter and/or prevents biological fluid (e.g., saliva, blood) from entering the treatment site and affecting the vision for surgery.

Accordingly, a borehole shield useful for performing an endodontic surgery which includes removing a portion of the alveolar bone of a subject to create a borehole for accessing a treatment site, the borehole shield of the present disclosure includes a body configured to fit the borehole and a sealable opening disposed on the body. The endodontic surgery is a periradicular surgery, and the treatment site is the root of a tooth. The sealable opening can form a seal around the treatment site to prevent surrounding biological fluid from entering the treatment site. The body allows the attachment of a mirror to reflect the image of the treatment site.

Additionally, the body of the borehole shield is hollow and/or has a tubular, cylindrical, conic, bullet-like, truncated cone, or customized shape. A portion of the body is made of an elastic material. The body has a length from about 0.2 cm to about 10 cm, an inner size from about 0.2 cm to about 10 cm, and a thickness from about 0.1 mm to about 3 mm. The sealable opening of the borehole shield has a size from about 3 mm to about 15 mm. The sealable opening of the borehole shield has a polygonal or circular shape.

Accordingly, the body of the borehole shield further includes a slit and/or a guiding mechanism to guide a surgical instrument to gain access to the treatment site, where the guiding mechanism is operatively connected to the body via an anchoring element. The guiding mechanism further includes an annular portion configured to allow a surgical instrument to pass therethrough and gain access to the treatment site.

Additionally, the anchoring element connects the guiding mechanism to the body via the slit disposed thereon. The guiding mechanism is slidable along the slit. The surgical instrument disclosed herein may be endoscopes, photo-taking devices, light sources, lasers, curettes, ultrasonically-powered tips, irrigation devices, and suction devices.

Accordingly, a method for performing a periradicular surgery on a subject suffering from a pathological condition at a treatment site in need of such surgery is disclosed. The method includes creating a borehole on an alveolar bone of the subject to reveal the treatment site, placing a borehole shield in the borehole such that the sealable opening form a seal around the treatment site, and applying treatment operations to the treatment site.

Accordingly, a method of preventing surrounding fluid to enter the endodontic treatment site is also disclosed. The method includes placing a borehole shield at the treatment site such that the sealable opening of the borehole shield forms a fluid-tight seal encompassing the treatment site.

Accordingly, an endodontic surgical kit includes an instruction insert reciting the method for performing a periradicular surgery on a subject suffering from a pathological condition at a treatment site in need of such surgery, which includes creating a borehole on an alveolar bone of the subject to reveal the treatment site, placing the borehole shield in the borehole such that the sealable opening form a seal around the treatment site, and applying treatment operations to the treatment site. The endodontic surgical kit further includes a borehole shield useful for performing an endodontic surgery which includes removing a portion of the alveolar bone of a subject to create a borehole for accessing a treatment site, the borehole shield includes a body configured to fit the borehole, and a sealable opening disposed on the body. The endodontic surgical kit can further include the borehole shield and a guiding mechanism for guiding a surgical instrument to access the treatment site, where the guiding mechanism is operatively connected to the body via an anchoring element.

Additionally, the endodontic surgical kit further includes one or more endodontic surgical instruments. The endodontic surgical instrument may be endoscopes, photo-taking devices, light sources, lasers, curettes, ultrasonically-powered tips, irrigation devices, and suction devices.

Other aspects and advantages of the disclosure will become apparent from the following detailed description, taken in conjunction with the accompanying drawings.

### BRIEF DESCRIPTION OF THE DRAWINGS

FIGS. 1A-1D are schematic diagrams of the borehole shield according to one embodiment of the present disclosure.

FIGS. 2A-2D are schematic diagrams of the borehole shield according to embodiments of the present disclosure.

FIGS. 3A-3B are schematic diagrams of the borehole shield with a guiding mechanism according to one embodiment of the present disclosure.

FIG. 4 is a schematic diagram of the borehole shield with a slit according to one embodiment of the present disclosure.

FIGS. 5A-5B are schematic diagrams of the borehole shield with a slit and a guiding mechanism according to one embodiment of the present disclosure.

FIG. 6 is a schematic diagram of the borehole shield with a mirror according to one embodiment of the present disclosure.

FIGS. 7A-7B are schematic flowcharts illustrating the steps of performing a periradicular surgery on a subject suffering from a pathological condition at a treatment site in need of such surgery according to one embodiment of the present disclosure.

FIGS. 8A-8L are schematic diagrams illustrating the process of performing a periradicular surgery by using the borehole shield according to one embodiment of the present disclosure.

FIG. 9 is a schematic diagram illustrating the endodontic surgical kit according to one embodiment of the present disclosure.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section. Components and achievement of a borehole shield according to the present disclosure may be illustrated in the following drawings and embodiments. However, the size and shape shown on drawings for the borehole shield do not limit the features of the present disclosure.

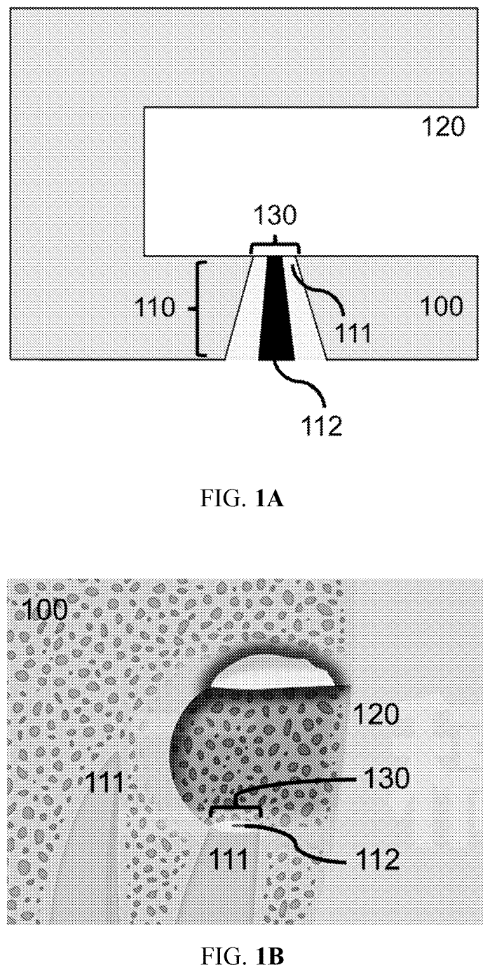

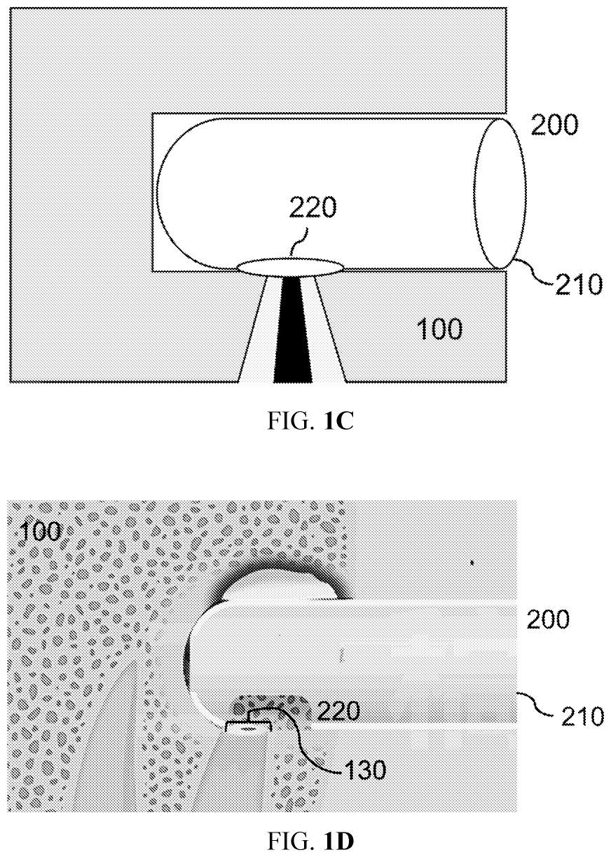

Embodiments of the present disclosure provide a borehole shield useful for performing endodontic surgery. Please refer to FIGS. 1A and 1B, endodontic surgery is needed to remove the diseased tissue surrounding the root apex 111 and the infected root canal wall and/or improper root canal filling 112 of the patient's tooth 110 (the crown part of the tooth is omitted for clarity). The endodontic surgery comprises removing a portion of the alveolar bone 100 of a subject to create a borehole 120 for accessing a treatment site 130. FIGS. 1C and 1D are schematic diagrams illustrating the borehole shield according to one embodiment of the present disclosure. The borehole shield 200 comprises a body 210 configured to fit borehole 120 and a sealable opening 220 disposed on the body. The sealable opening is capable of forming a seal around the treatment site 130 to prevent surrounding biological fluid from entering the treatment site. The endodontic surgery may be a periradicular surgery and the treatment site may be the root of a tooth. The biological fluid may be blood or saliva.

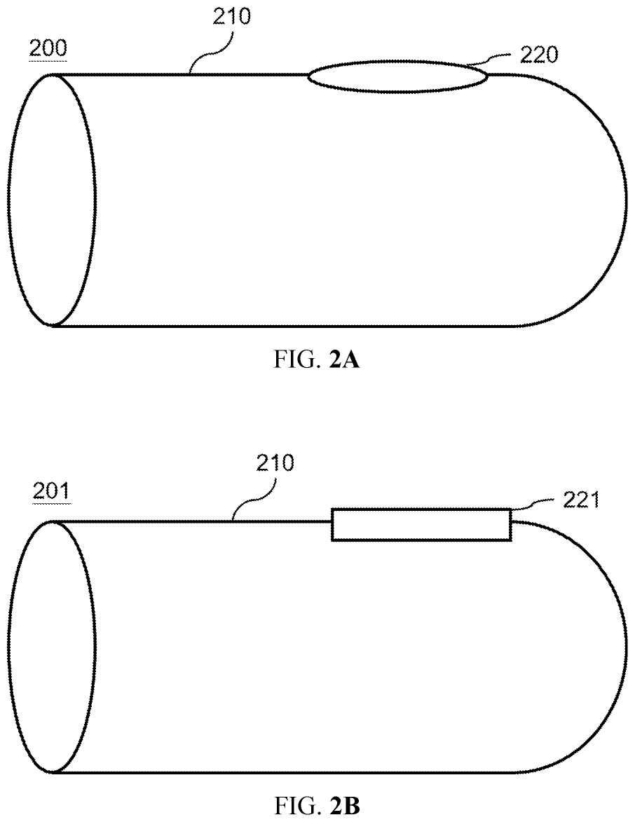

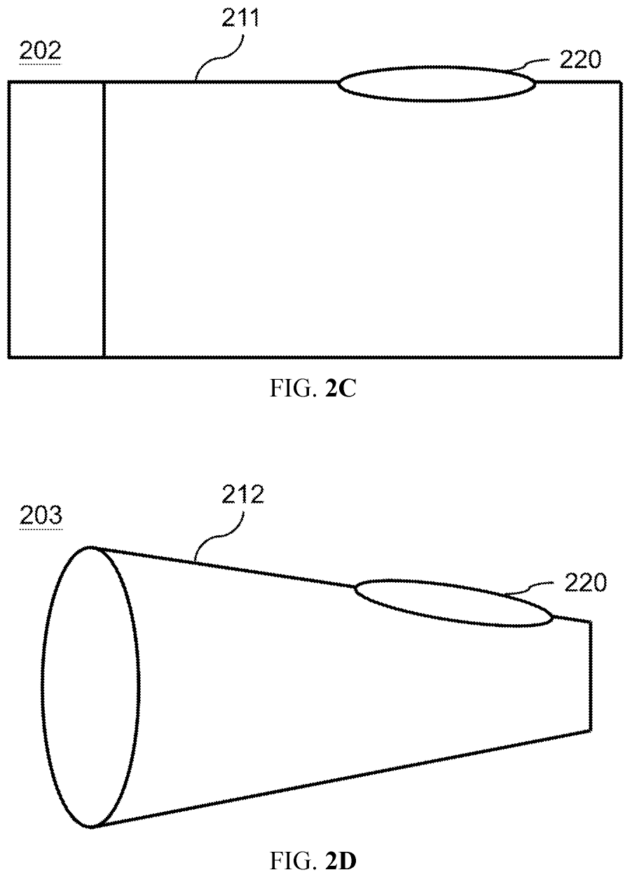

FIGS. 2A-2D are schematic diagrams of the borehole shield according to embodiments of the present disclosure. In some embodiments, the body of the borehole shield (200-203) may be hollow. The body may have a tubular shape, a cylindrical shape (211), a conic shape, a bullet-like shape (210), a truncated cone shape (212), or a customized shape (e.g., by computer designed according to patient's personal condition). The cross-section of the body may be circular (as shown in FIGS. 2A, 2B, and 2D) or polygonal (e.g., a rectangle shown in FIG. 2C). A portion of the body is made of an elastic material, for example, rubber, latex, silicone rubber, and thermoplastic. Different materials such as metallic materials (e.g., aluminum, titanium, steel, and an alloy thereof) or plastic materials can be used. The body of the borehole shield has a length from about 0.2 cm to about 10 cm, an inner size from about 0.2 cm to about 10 cm, and a thickness from about 0.1 mm to about 3 mm. The sealable opening may have a circular shape (220) or a polygonal shape (e.g., rectangle 221 shown in FIG. 2B). Other shapes such as a star shape, an ellipse shape, a pentagon shape, and a customized shape (e.g., by computer designed according to patient's personal condition) are also applicable. The sealable opening of the borehole shield may have a size from about 3 mm to about 15 mm.

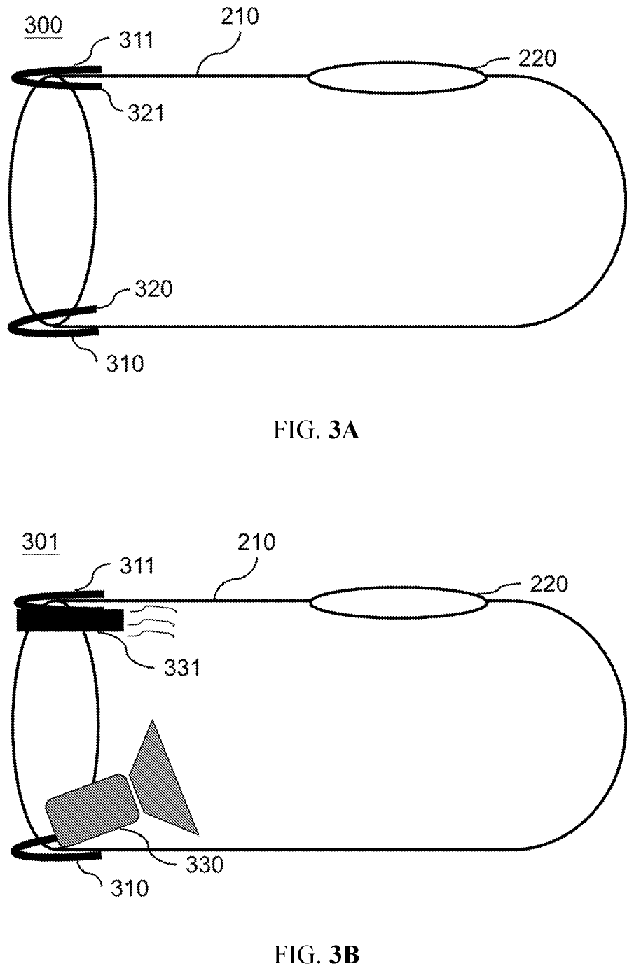

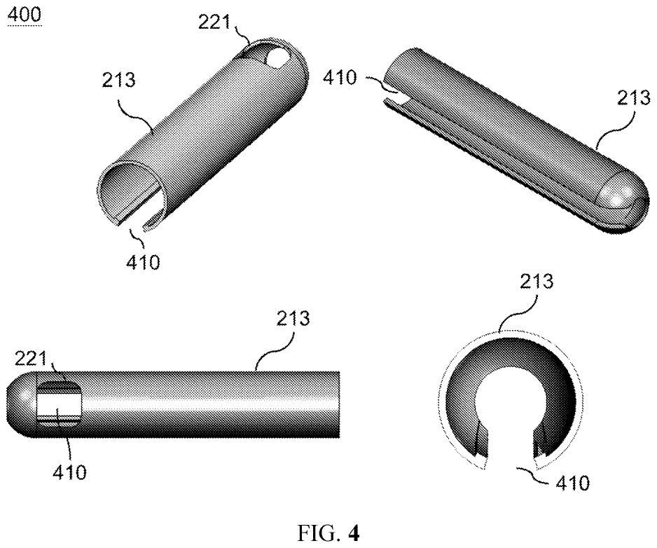

FIGS. 3A-3B are schematic diagrams of the borehole shield with a guiding mechanism according to one embodiment of the present disclosure. The borehole shield 300 further comprises guiding mechanisms (310 and 311) for guiding a surgical instrument (e.g., a light source 330 and an irrigation device 331 shown in FIG. 3B) to access the treatment site. The guiding mechanism is operatively connected to the body via an anchoring element (320 and 321). The guiding mechanism may move along the body to adjust the access position and the access angle for the surgical instrument. A portion of the guiding mechanism and/or the anchoring element is made of an elastic material, for example, rubber, latex, silicone rubber, and thermoplastic. Different materials such as metallic materials (e.g., aluminum, titanium, steel, and an alloy thereof) or plastic materials can be used.

FIG. 4 is a schematic diagram of the borehole shield with a slit according to one embodiment of the present disclosure. The borehole shield 400 further comprises a slit 410. The slit may provide an adjustable inner size of the body due to the compressible structure. When the borehole shield with a slit is compressed and placed into the borehole, it expands and the expanded structure not only fits the borehole but also has a strain to increase the pressure applied on the wall of the borehole and further stop the bleeding, which reduces the amount of surrounding biological fluid. The width of the slit may be from about 0.5 mm to about 5 mm.

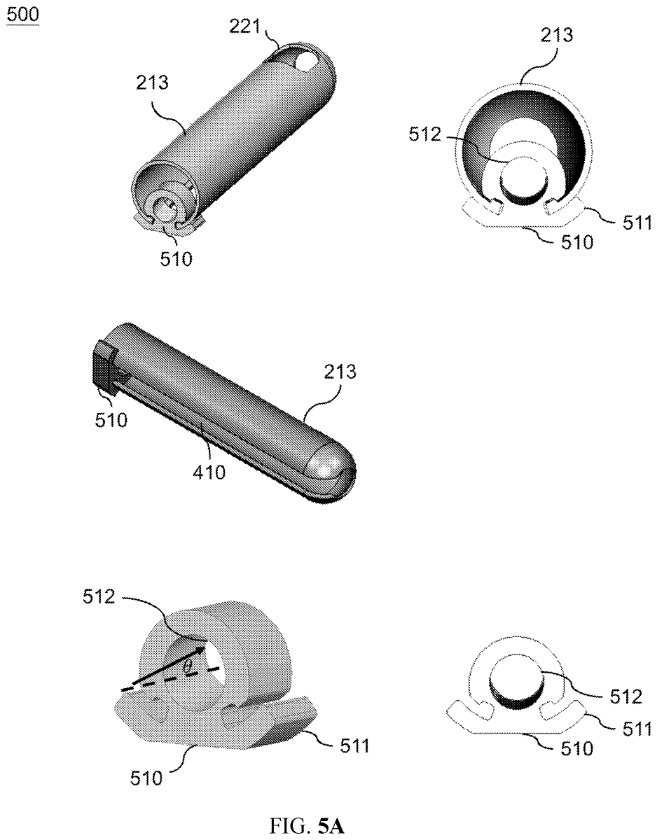

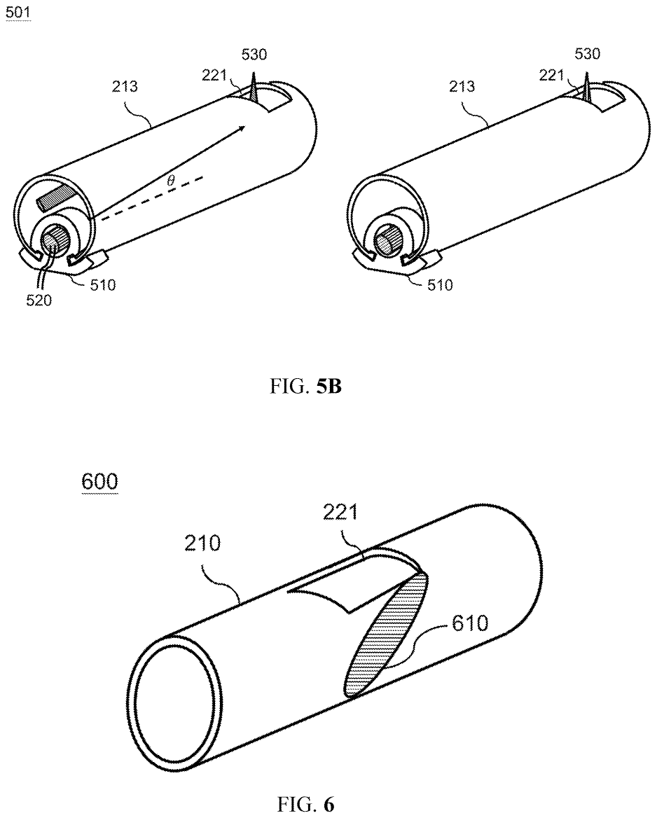

FIGS. 5A-5B are schematic diagrams of the borehole shield with a slit and a guiding mechanism according to one embodiment of the present disclosure. The borehole shield 500 comprises a body 213 configured to fit the borehole, a sealable opening 221 disposed on the body, and a guiding mechanism 510 for guiding a surgical instrument to access the treatment site. The guiding mechanism 510 is operatively connected to the body via an anchoring element 511. The guiding mechanism 510 comprises an annular portion 512 configured to allow a surgical instrument passing therethrough to guide the surgical instrument's access to the treatment site. The inner size of the annular portion may be from about 0.5 mm to about 5 mm. As shown in FIG. 5A, the body 213 further comprises a slit 410 disposed thereon, and the anchoring element 511 connects the guiding element 510 to the body 213 via the slit 410. The guiding mechanism 510 is capable of being slidably displaced along the slit 410. To guide the surgical instrument's access to the treatment site, the annular portion 512 may have an access angle 0 from about 5 degrees to about 15 degrees relative to the horizontal axis (dotted line shown in FIGS. 5A and 5B) of the guiding mechanism 510. As shown in FIG. 5B, the guiding mechanism 510 comprises an annular portion configured to allow a surgical instrument (e.g., an endoscope 520 or an ultrasonically-powered tip 530) passing therethrough to guide the surgical instrument's access to the treatment site. The surgical instrument disclosed herein may be endoscopes, photo-taking devices, light sources, lasers, curettes, ultrasonically-powered tips, irrigation devices, and suction devices.

FIG. 6 is a schematic diagram of the borehole shield with a mirror according to one embodiment of the present disclosure. The body 210 of the borehole shield 600 further comprises a mirror 610 adapted to reflect an image of the treatment site. Such structure provides flexibility for certain angles which is difficult to observe, the dentist can observe the image of the treatment site through the mirror directly or by using an endoscope as previously disclosed. The mirror's size, angle, and position can be adjusted according to the patient's condition, e.g. the location of the treatment site and the depth of the borehole.

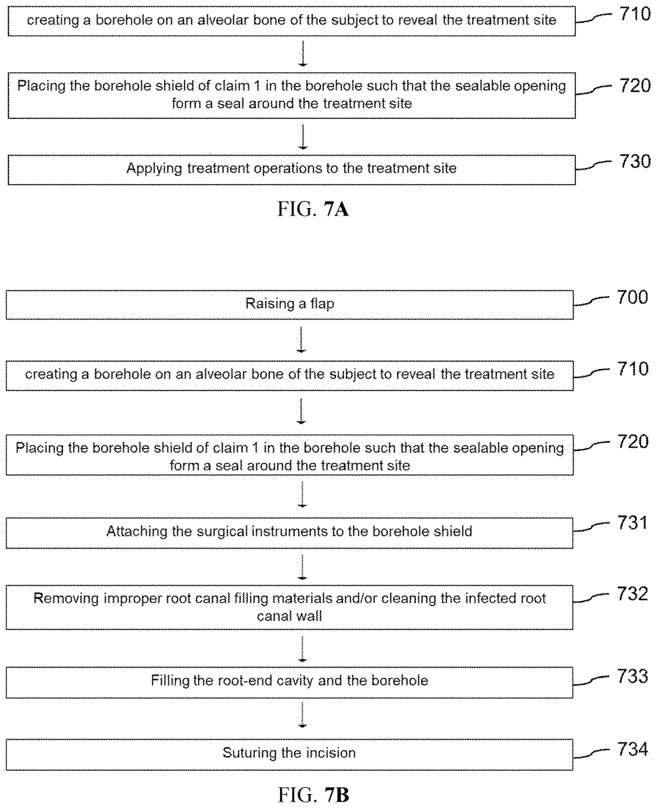

FIG. 7A is a schematic flowchart illustrating the steps of performing a periradicular surgery on a subject suffering from a pathological condition at a treatment site in need of such surgery according to one embodiment of the present disclosure, which recites the steps of creating a borehole on an alveolar bone of the subject to reveal the treatment site, placing the borehole shield in the borehole such that the sealable opening form a seal around the treatment site, and applying treatment operations to the treatment site.

Accordingly, the steps of performing a periradicular surgery on a subject suffering from a pathological condition at a treatment site in need of such surgery are shown in FIG. 7A. The steps include:

Step 710: A borehole is created on an alveolar bone of the subject suffering from a pathological condition to reveal the treatment site. The position to create the borehole can be located by pre-operative X-ray (e.g., 3D cone beam computed tomography). The borehole may be created through osteotomy using a standard drill, bone trephine, or alveolar expanders. In some embodiments, a portion of the pathological tissues and/or the root apex may be removed while creating the borehole. If some debris or residual of the pathological tissues and/or the root apex are not removed during the drilling, a bone curette or a tip can be used to remove them. The bleeding from the cortical plate, tissues, or bones may be reduced by using laser cautery and hemostatic cotton. The size of the borehole may be expanded stepwise, e.g., from a 1.5 mm pilot hole, gradually increasing to 3.3 mm, 3.5 mm, to 5.7-6 mm. Before the expansion of the borehole, the position, direction, and depth of the pilot hole can be confirmed by X-ray (e.g., 3D cone beam computed tomography). The size of the borehole can be controlled by the size of the drills, trephine burs, or expanders, which is a standard process for a skilled person. The size of the borehole can be determined by the bleeding condition, for example, if the bleeding is heavy at the size of 5.7 mm, it should not be further expanded.

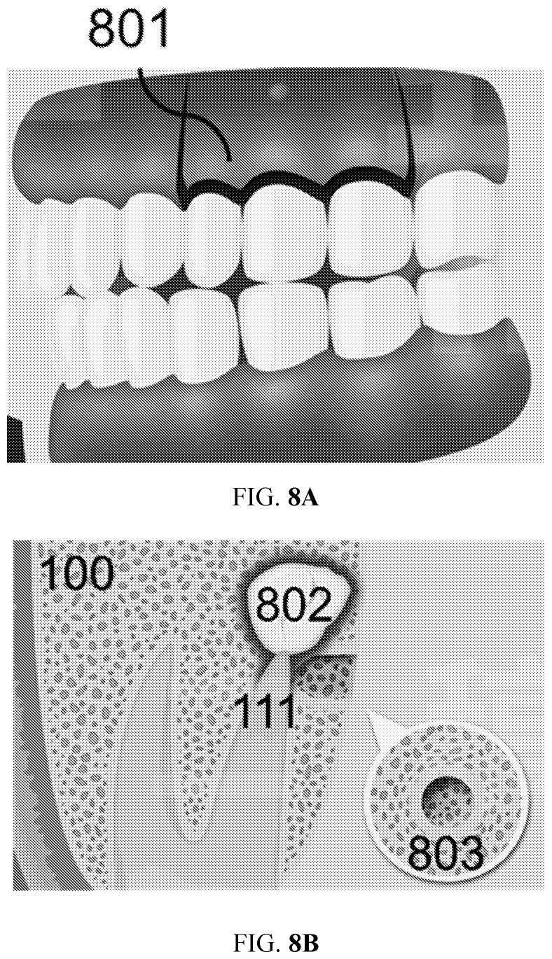

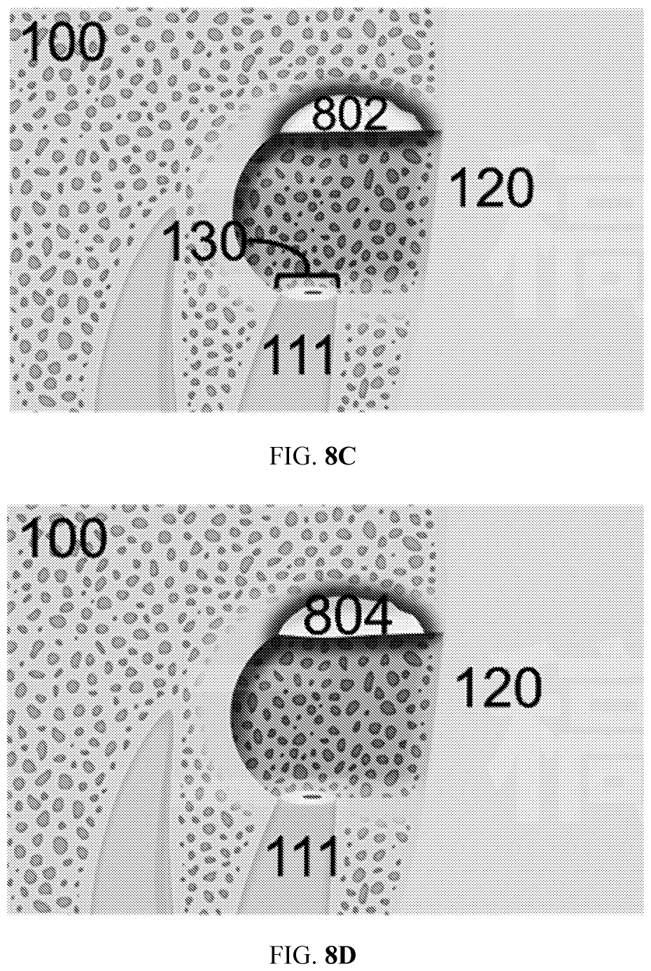

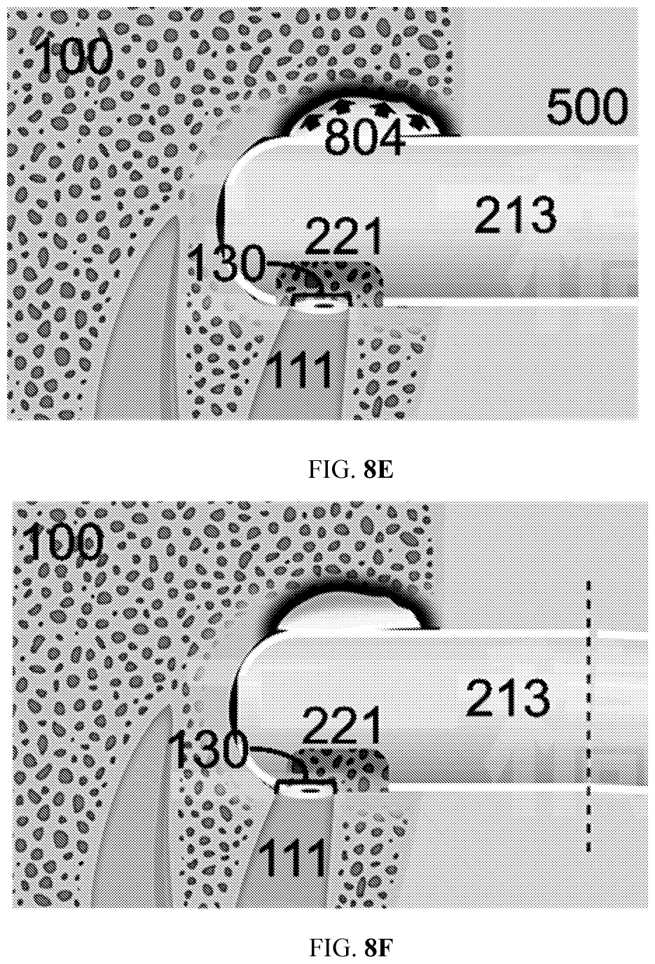

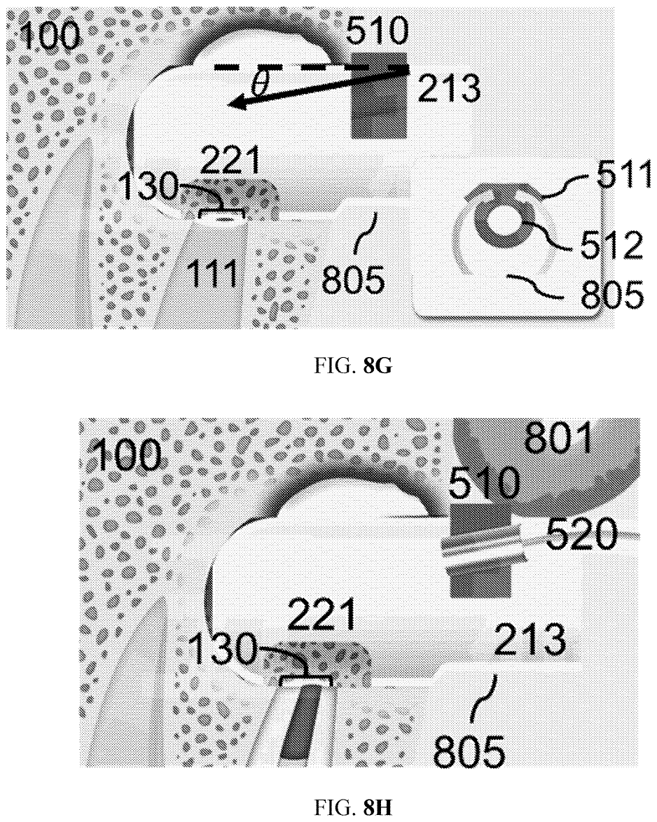

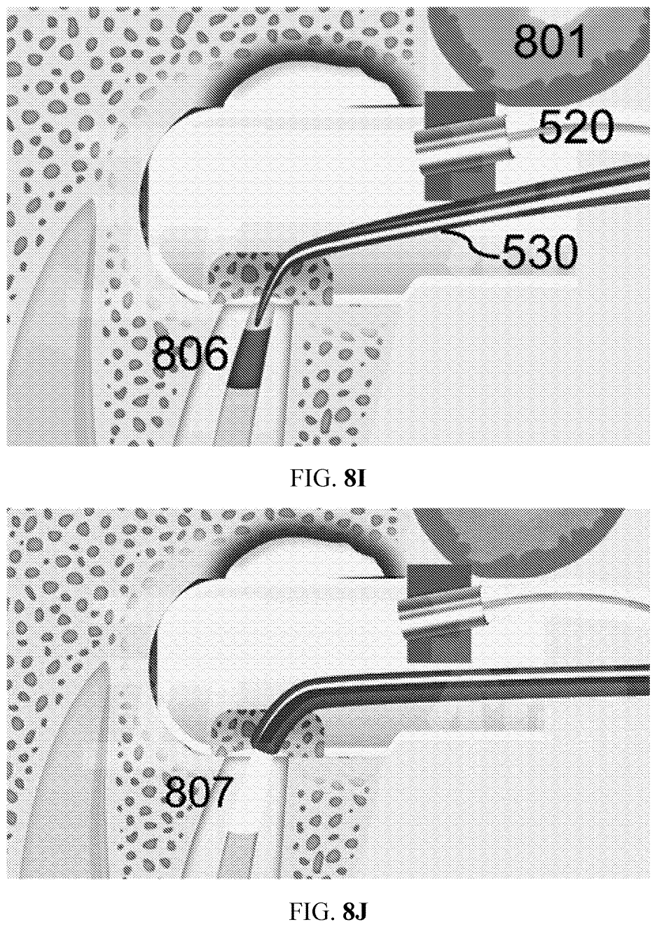

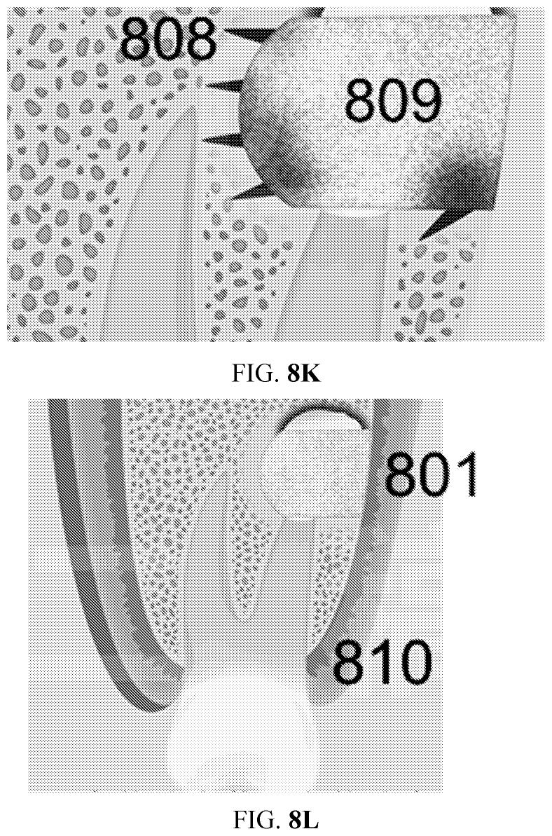

Step 720: The previously disclosed borehole shield is placed in the borehole such that the sealable opening form a seal around the treatment site. The inner size of the borehole shield may be slightly larger than the size of the borehole so that the borehole shield applies pressure against the wall of the borehole as well as the hemostatic cotton to stop bleeding. The sealable opening may align with the treatment site and form a seal around it to prevent the surrounding biological fluid (e.g., blood and saliva) from entering the treatment site. The borehole shield may be modified before or after the placement in the borehole. The modification includes but is not limited to creating an opening, adjusting the opening size, adjusting the sealable opening size, and cutting the borehole shield. For example, a portion of the body can be removed to improve the accessibility of the ultrasonically-powered tip (See also recess 805 of FIG. 8G). A guiding mechanism for guiding a surgical instrument to access the treatment site may be operatively connected to the body of the borehole shield before or after the placement in the borehole. The guiding mechanism can be adjusted to provide desired position and angle for the surgical instrument to access the treatment site.

Step 730: Treatment operations are applied to the treatment site. The treatment operations include but are not limited to endodontic surgery, periradicular surgery, apicoectomy, apicectomy, retrograde filling, and root-end filling.

FIG. 7B is another schematic flowchart illustrating the steps of performing a periradicular surgery on a subject suffering from a pathological condition at a treatment site in need of such surgery according to one embodiment of the present disclosure, which illustrates a detailed embodiment of the schematic flowchart shown in FIG. 7A.

Accordingly, the steps of performing a periradicular surgery on a subject suffering from a pathological condition at a treatment site in need of such surgery are shown in FIG. 7B. The steps further include:

Step 700: A flap of tissue that may be lifted and kept in a position for the following step 710 to create a borehole. A proper flap can result in proper access and post-operative healing. The flap may include but is not limited to full mucoperiosteal flaps (e.g., 2-sided (triangular), 3-sided (rectangular, trapezoidal), envelope) and limited mucoperiosteal flaps (e.g., semilunar, Luebke-Ochsenbein).

Step 731: The surgical instruments may be attached to the borehole shield before the treatment operation. The surgical instrument disclosed herein may be endoscopes, photo-taking devices, light sources, lasers, curettes, ultrasonically-powered tips, irrigation devices, and suction devices. In one embodiment, using the endoscopes provides advantages such as (1) the endoscope can still observe the treatment site in the liquid environment. The exposed treatment site can be flushed or irrigation without suction, and the borehole shield prevent the surrounding biological fluid from entering the treatment site assures the vision of the operating field; (2) the root structure can be preserved to the max to maintain the occlusal function due to the required size of the borehole is relatively small compared with the traditional method (using microscopes and/or mouth mirrors), which may have the risk of removing excess bone; and (3) The bone window (as well as the wound size) is much smaller for observation by an endoscope than traditional microscopes and/or mouth mirrors. The small osseous window shortens the healing time due to the small wound size.

Step 732: The improper root canal filling materials are removed, and/or the infected root canal wall is cleaned. An ultrasonically-powered tip can be used to provide advantages such as deeper preparation, conserving the root structure, and a clean root-end cavity from debris and smear layer. In another embodiment, a laser (e.g., Er-YAG laser) can also be used to remove improper root canal filling materials and/or to clean the infected root canal wall.

Step 733: The cavity created at step 732 and the borehole is filled at step 733. The retrograde filling material of the root-end cavity may include but is not limited to amalgam, ZOE (zinc oxide eugenol cement), IRM (intermediate restorative material, ZOE reinforced with polymethyl methacrylate), super-EBA (ZOE reinforced with ethoxy benzoic acid), and MTA (mineral trioxide aggregate, calcium silicate-based filling material). The borehole is filled with bone graft material. To enhance the strength and increase the healing speed as well as the blood supply, several small boreholes can be created before the filling of the materials.

Step 734: After the operation, the flap is returned to the original position, and the incision is sutured.

FIGS. 8A-8L are schematic diagrams illustrating the process of performing a periradicular surgery by using the borehole shield according to one embodiment of the present disclosure. FIG. 8A illustrates step 700, a flap of tissue 801 that may be lifted and kept in a position for the following step 710 to create a borehole. FIGS. 8B-8D illustrate step 710, a pilot hole 803 is created on an alveolar bone 100 of the diseased tissue 802 surrounding the root apex 111 (FIG. 8B). Then a borehole 120 is created to reveal the treatment site 130 (FIG. 8C). A portion of the pathological tissues 802 and the root apex 111 are removed while creating the borehole. Some residual of the pathological tissues 802 are removed by a bone curette or a tip, and the bleeding from the cortical plate, tissues, or bones may be reduced by using laser cautery and hemostatic cotton 804 (FIG. 8D). FIGS. 8E-8G illustrate step 720, the previously disclosed borehole shield 500 is placed in borehole 120 such that the sealable opening 221 form a seal around the treatment site 130. The borehole shield 500 applies pressure against the wall of the borehole as well as the hemostatic cotton 804 to stop bleeding (FIG. 8E). The borehole shield 500 is cut after the placement in the borehole to the desired length, where the exposed portion of the body can prevent the blood (mostly from the cortical plate) from entering the treatment site (FIG. 8F). A portion of the body 213 can be removed to form a recess 805 to improve the accessibility of the ultrasonically-powered tip 530 (See also FIG. 8I). The width of the recess may be from about 0.5 mm to about 5 mm. A guiding mechanism 510 for guiding a surgical instrument to access the treatment site is operatively connected to the body 213 of the borehole shield 500. To guide the surgical instrument's access to the treatment site, the annular portion 512 may have an access angle 0 from about 5 degrees to about 15 degrees relative to the horizontal axis (dotted line) of the guiding mechanism 510 (FIG. 8G). FIGS. 8H-8L illustrate steps 730-734, in step 731, the endoscope 520 is attached to the borehole shield passing through the annular portion 512 of the guiding mechanism 510 before the treatment operation (FIG. 8H). In step 732, the improper root canal filling materials 806 are removed, and/or the infected root canal wall is cleaned by an ultrasonically-powered tip 530 (FIG. 8I). In step 733, the cavity created at step 732 is filled with the retrograde filling material 807 (FIG. 8J). The borehole 120 is filled with bone graft material 809, to enhance the strength and increase the healing speed as well as blood supply, several small boreholes 808 can be created before the filling of the materials (FIG. 8K). In step 734, flap 801 is returned to the original position, and incision 810 is sutured after the treatment operation (FIG. 8L).

Accordingly, a method of preventing surrounding fluid to enter into an endodontic surgical treatment site according to one embodiment of the present disclosure is disclosed, which recites the step of placing the borehole shield at the treatment site such that the sealable opening of the borehole shield form a fluid-tight seal encompassing the treatment site.

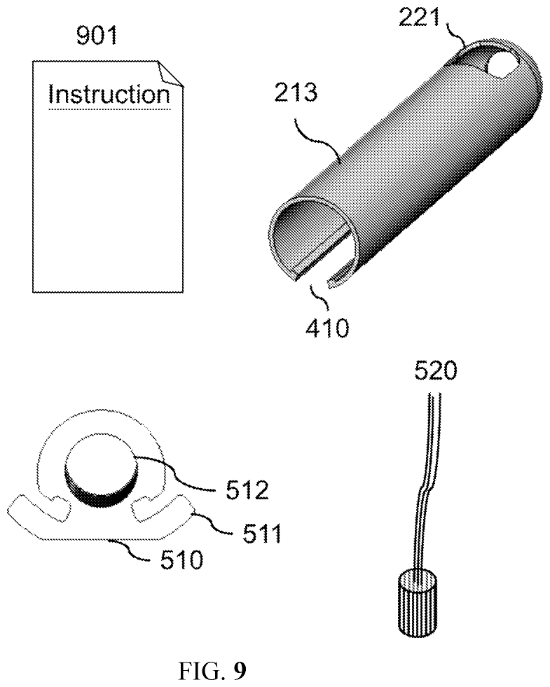

FIG. 9 is a schematic diagram illustrating the endodontic surgical kit according to one embodiment of the present disclosure. The endodontic surgical kit 900 comprises an instruction 901 insert reciting the method for performing a periradicular surgery on a subject suffering from a pathological condition at a treatment site in need of such surgery as previously disclosed. Instruction 901 may be in paper or electronic form (e.g., electronic documents, voice-recorded instruction). The endodontic surgical kit 900 may further comprise the borehole shield as previously disclosed, such as the borehole shield 400 comprises a slit 410. The endodontic surgical kit 900 may further comprise the guiding mechanism as previously disclosed, such as the guiding mechanism 510 comprising an anchoring element 511 and an annular portion 512. The endodontic surgical kit 900 may further comprise one or more endodontic surgical instruments including but not limited to endoscopes 520, photo-taking devices, light sources, lasers, curettes, ultrasonically-powered tips, irrigation devices, and suction devices.

Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present disclosure covers modifications and variations that come within the scope of the appended claims and their equivalents.

What is claimed is:

1. A borehole shield useful for performing an endodontic surgery wherein said endodontic surgery comprises removing a portion of the alveolar bone of a subject to create a borehole for accessing a treatment site, said borehole shield comprising:
a body configured to fit the borehole; and
a sealable opening disposed on the body,
wherein said sealable opening is capable of forming a seal around the treatment site to prevent surrounding biological fluid from entering the treatment site.

2. The borehole shield of claim 1, wherein the endodontic surgery is a periradicular surgery and the treatment site is the root of a tooth.

3. The borehole shield of claim 1, wherein the body is hollow.

4. The borehole shield of claim 1, wherein the body has a shape selected from the group consisting of tubular, cylindrical, conic, bullet-like shape, truncated cone, and customized shape.

5. The borehole shield of claim 1, wherein a portion of the body is made of an elastic material.

6. The borehole shield of claim 1, wherein the body has:
a length from about 0.2 cm to about 10 cm;
an inner size from about 0.2 cm to about 10 cm; and
a thickness from about 0.1 mm to about 3 mm.

7. The borehole shield of claim 1, wherein the sealable opening has a size from about 3 mm to about 15 mm.

8. The borehole shield of claim 1, wherein the sealable opening has a polygonal or circular shape.

9. The borehole shield of claim 1, wherein the body further comprises a slit.

10. The borehole shield of claim 1 further comprises a guiding mechanism for guiding a surgical instrument to access the treatment site, wherein said guiding mechanism is operatively connected to the body via an anchoring element.

11. The borehole shield of claim 10, wherein the guiding mechanism further comprises an annular portion configured to allow a surgical instrument passing therethrough so as to guide the surgical instrument's access to the treatment site.

12. The borehole shield of claim 11, wherein the body further comprises a slit disposed thereon.

13. The borehole shield of claim 12, wherein the anchoring element connects the guiding mechanism to the body via the slit.

14. The borehole shield of claim 13, wherein the guiding mechanism is capable of being slidably displaced along the slit.

15. The borehole shield of claim 14, wherein the surgical instrument is selected from the group consisting of endoscopes, photo-taking devices, light sources, lasers, curettes, ultrasonically-powered tips, irrigation devices, and suction devices.

16. The borehole shield of claim 1 wherein the body further comprises a mirror adapted to reflect an image of the treatment site.

17. A method for performing a periradicular surgery on a subject suffering from a pathological condition at a treatment site in need of such surgery, comprising:
creating a borehole on an alveolar bone of the subject to reveal the treatment site;
placing the borehole shield of claim 1 in the borehole such that the sealable opening form a seal around the treatment site; and
applying treatment operations to the treatment site.

18. A method of preventing surrounding fluid to enter into an endodontic surgical treatment site, comprising:
placing the borehole shield of claim 1 at the treatment site such that the sealable opening of the borehole shield form a fluid-tight seal encompassing the treatment site.

19. An endodontic surgical kit, comprising:
an instruction inserts reciting the method of claim 17.

20. The kit of claim 19, further comprises the borehole shield of claim 1.

21. The kit of claim 19, further comprises the borehole shield of claim 10.

22. The kit of claim 19, further comprises one or more endodontic surgical instruments.

23. The kit of claim 22, wherein the endodontic surgical instrument is selected from the group consisting of endoscopes, photo-taking devices, light sources, lasers, curettes, ultrasonically-powered tips, irrigation devices, and suction devices.
